(19) United States
(12) Patent Application Publication
(10) Pub. No.: US 2009/0042551 A1
(43) Pub. Date: Feb. 12, 2009

(54) DYNAMIC MULTIMEDIA DATA CODING METHOD FOR CELL PHONES

(75) Inventors: Shih-Kuang TSAI, Shanghai City (CN); Liang Huang, Shanghai City (CN); Peng Lin, Shanghai City (CN)

Correspondence Address: Muncy, Geissler, Olds & Lowe, PLLC, P.O. BOX 1364, FAIRFAX, VA, 22038-1364, US

(73) Assignee: INVENTEC APPLIANCES CORP.

(21) Appl. No.: 12/188,965

(22) Filed: Aug. 8, 2008

(30) Foreign Application Priority Data
Aug. 9, 2007 (TW) 96129458

(51) Int. Cl. H04M 3/00

(52) U.S. Cl. 455/418

(57) ABSTRACT

A multimedia data coding method for cell phones is provided, wherein the multimedia data coding method comprises steps as follows: First multimedia data is captured by a first cell phone, and then a coding parameter is determined by selecting a coding mode. Subsequently the multimedia data is coded according to the coding mode and the coding parameter to output a signal. The signal is then transmitted to a second cell phone.

### RELATED APPLICATIONS

This application claims priority to Taiwan Application Serial Number 96129458, filed Aug. 9, 2007, which is herein incorporated by reference.

### FIELD OF THE INVENTION

The present invention relates to a multimedia data coding method for cell phones, and more particularly relates to a multimedia data dynamic coding method for cell phones.

### BACKGROUND OF THE INVENTION

With improvements in communication technology, the existing business functions provided by traditional second-generation mobile communication network (global positioning system; GSM) cannot satisfy customer business demands. To fulfill such customer demands, a third-generation (3G) mobile communication network with high speed and multiple functions has gradually replaced the second-generation mobile communication network, wherein the 3G mobile communication network is distinguished by providing image services, whose application are more and more popular.

Generally, video and audio signal continuity and quality are crucial to the quality of mobile communication. However the signal transmission of the current 3G mobile communication network is not stable. For example, the signal intensity of the 3G mobile communication network varies between different places and different times, and the signal transmission may even be interrupted easily thus causing the problems of poor image quality or discontinuity.

Therefore, it is desirable to provide an advanced multimedia coding method to remedy the transmission variation of the 3G mobile communication network to provide the cell phones with a continuous signal.

### SUMMARY OF THE INVENTION

One aspect of the present invention is to provide a multimedia data dynamic coding method for cell phones, wherein the method comprises steps as follows: First multimedia data is captured by a first cell phone, and then a coding parameter is determined by selecting a coding mode. Subsequently the multimedia data is coded according to the coding mode and the coding parameter to output a signal. The signal is then transmitted to a second cell phone.

In accordance with the embodiments of present invention, the characteristics of the present invention are to select a coding mode to dynamically code the multimedia data captured by a first cell phone according to the coding mode and a coding parameter, and to transmit the coded multimedia data to a second cell phone through a mobile communication network, wherein the coding mode and the coding parameter can be selected depending upon the performance of the mobile communication network, such as the flow rate, to protect the transmission of the media information from breaking off. Hence, problems caused by undesired variations of the flow rate of a mobile communication network can be resolved.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a systematic diagram of a 3G mobile communication network 100 currently applied in cell phone's communication.

FIG. 2 illustrates a flow chart of a multimedia data dynamic coding method 200 to for cell phones in accordance with a preferred embodiment of the present invention.

FIG. 3 illustrates a selecting menu 300 of the “setting” function list under the main menu of the first cell phone 101 in accordance with the preferred embodiment of the present invention.

FIG. 4 illustrates a flow chart of a multimedia data dynamic coding method 400 for cell phones in accordance with another preferred embodiment of the present invention.

FIG. 5 illustrates a flow chart of a multimedia data dynamic coding method 500 for cell phones in accordance with further another preferred embodiment of the present invention.

### DETAILED DESCRIPTION OF THE PREFERRED EMBODIMENT

The objects of the present invention are to provide a multimedia data dynamic coding method to improve the quality of multimedia data transmission and signal continuation between cell phones, when a mobile communication network is crowded or the signal strength is unstable.

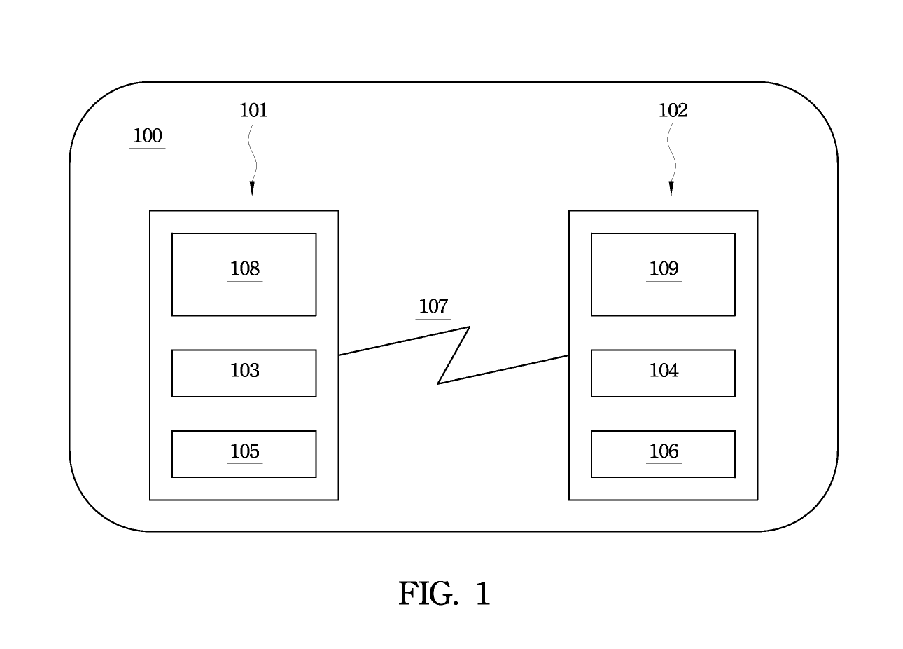

FIG. 1 illustrates a systematic diagram of a 3G mobile communication network 100 currently applied in mobile communications. In the present embodiment, the 3G mobile communication network 100 is a wireless network system with at least two cell phones, such as cell phones 101 and 102, wherein the network 107 connects the two cell phones 101 and 102. Each cell phone 101 and 102 can respectively capture image and audio data via the built-in digital camera and microphone. For example in the present embodiment, the cell phone 101 has a built-in digital camera 103 and a microphone 104 used to capture images and sound; the cell phone 102 has a built-in digital camera 105 and a microphone 106 used to capture images and sound. The images and audio data captured by the cell phones 101 or 102 are then coded into a signal and transmitted to from cell phone 101 to cell phone 102 or from cell phone 102 to cell phone 101 through the network 107. The signal transmitted through the network 107 can be decoded and then be displayed by the liquid crystal display 109 (or 108) and the speakers (not shown) built in the second cell phone 102 (or 101) that receives the signal.

Currently, the 3G mobile communication network 100 is mainly used to transmit media signals such as video data and audio data. Algorithms, such as ARM and AAC are used to compress the audio data for signal transmission, wherein the ARM and AAC have similar compression ratios and both of them can produce very stable signals. Otherwise, H263 and MPEG4 algorithms compress the video data with quite different compression ratios. In the present embodiment, an improved multimedia data dynamic coding method is provided dynamically to select the compressing algorithms and to rearrange the signal produced by these algorithms depends upon the variation of the flow rate performed by the 3G mobile communication network, so as to prevent the signal transmission from break off. Thus the users of the 3G mobile communication network can receive continuation images and sound displayed by the cell phone.

The foregoing aspects and many of the attendant advantages of this invention will become more readily appreciated as the same becomes better understood by reference to the following embodiments and the embodiments of the present invention are illustrated of the present invention rather than limiting of the present invention.

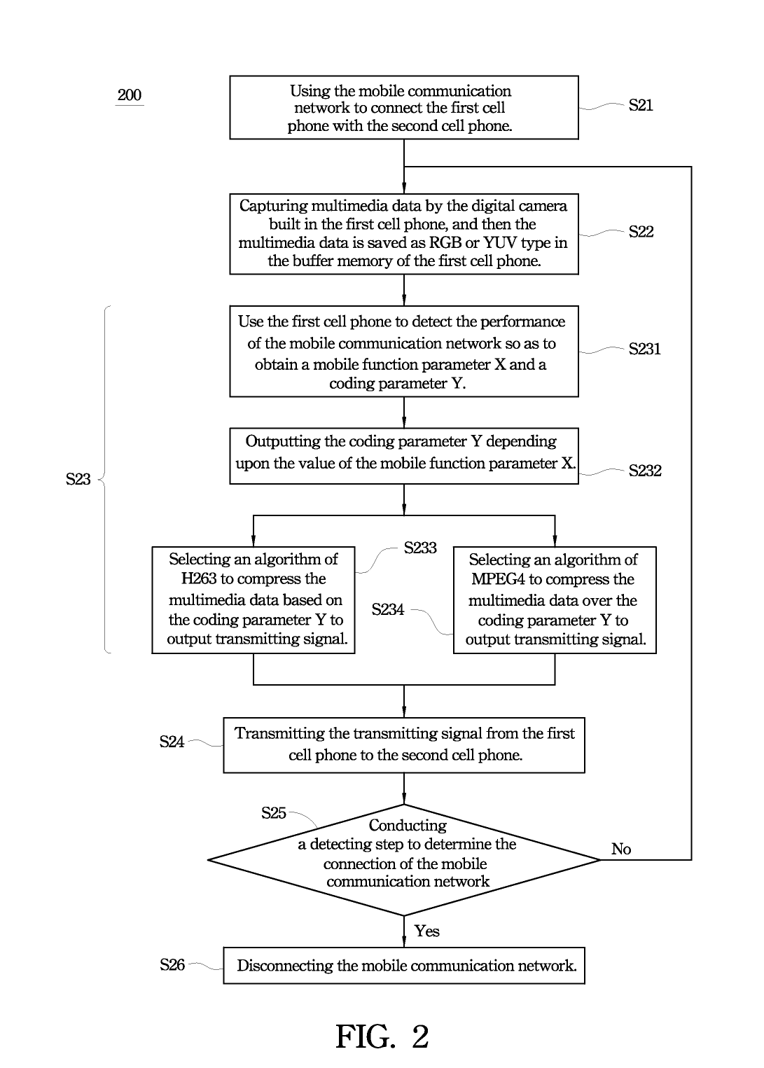

FIG. 2 illustrates a flow chart of a method 200 to dynamically code multimedia information of cell phones in accordance with a preferred embodiment of the present invention. Wherein the method 200 comprises steps as follows: First, the mobile communication network 107 connects the first cell phone 101 to the second cell phone 102 as shown in FIG. 1 (referring to the step S21). A step S22 is then conducted to capture media information. For example in the present invention, media information is captured by the digital camera 103 built in the first cell phone 101, and then the media information is saved as RGB or YUV type in the buffer memory (not shown) in the first cell phone 101.

Subsequently, in step S23 a coding mode is selected so as to determine the coding parameters. In some embodiments of the present invention, the first cell phone 101 provides the users a selection menu under the “setting” function list of the main menu to select the proper coding mode for compressing video data.

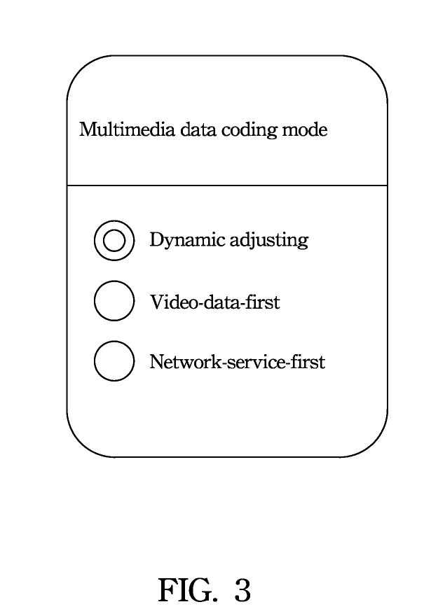

FIG. 3 illustrates a selection menu 300 under the “setting” function list of the main menu of the first cell phone 101 in accordance with the preferred embodiment of the present invention. In the present embodiment, the selection menu 300 of the first cell phone 101 provides the users various choices for the selections of coding mode, such as a “dynamic adjusting mode”, an “video-data-first mode” and a “network-service-first mode”, to determine the coding parameter base on which the video data captured by the digital camera 105 can be compressed into transmitting signal. Wherein, the “dynamic adjusting mode” provides a function to proportionally control the volume of the signal being transmitted in accordance with the actual flow rate of the mobile network 107. The “video-data-first mode” provides a function to transmit the compressed video data and halt other signals (such as the compressed audio data) without respect to the flow rate of the mobile network 107, such that video data can be transmitted and received continually. The “network-service-first mode” provides a faction to halt the transition of the compressed video data and the other signal has the transmission priority, when the flow rate of the mobile network 107 is low.

Referring to the step S231 in FIG. 2, in the present embodiment the dynamic adjusting mode is selected. First, the first cell phone 101 detect the performance of the mobile communication network 107, such as the flow rate, so as to obtain a mobile function parameter X and a coding parameter Y. In the present embodiment, the mobile function parameter X represents the flow rate of the mobile communication network 107. For example, compared with a predetermined situation, when an improvement in the mobile communication network 107 flow rate is detected, the value of the mobile function parameter X can be increased; otherwise when the mobile communication network 107 flow rate deteriorates, the mobile function parameter X is decreased. The coding parameter Y is obtained depending upon the value of the mobile function parameter X (referring to step S232). In the present embodiment, the coding parameter Y is a function of the mobile function parameter X, and the relation between X and Y can be represented by the formula Y=log X.

Subsequently, the multimedia data is coded based on the coding parameter Y to output transmission signal. In the present embodiment an the H263 algorithm (referring to step S233) or MPEG4 algorithm of (referring to step S234) is selected to compress the video data saved in the buffer memory (not shown) with reference to a predetermined coding parameter Y/compression ratio sheet to output transmission signal.

When the flow rate of the mobile communication network 107 is low, a small coding parameter Y is obtained and the video data is compressed by a high compression ratio so as to reduce the volume of the transmitting signal (the compressed video data) and save the transmitting capacity of the mobile communication network 107. Otherwise, when the flow rate of the mobile communication network 107 is high, a large coding parameter Y is obtained and the video data is compressed by a low compression ratio, such that the transmitting signal (of the compressed video data) can be redisplayed by the second cell phone 102 that receives thereof with better quality, for example with better resolutions. Meanwhile when the flow rate of the mobile communication network 107 is normal, a medium coding parameter Y is obtained and the video data is compressed by a predetermined compression ratio.

After the video data is compressed the step S24 is conducted, wherein the transmitting signal is then transmitted from the first cell phone 101 to the second cell phone 102. A detecting step S25 is then conducted to determine the connection of the mobile communication network 107 between the first cell phone 101 and the second cell phone 102. If the connection of the mobile communication network 107 is continuous, a loop of steps S21, S22, S23, S24 and S25 are continually conducted until the connection is broken off. When the user wants to cease or terminate the transmission, step S26 disconnects the mobile communication network 107.

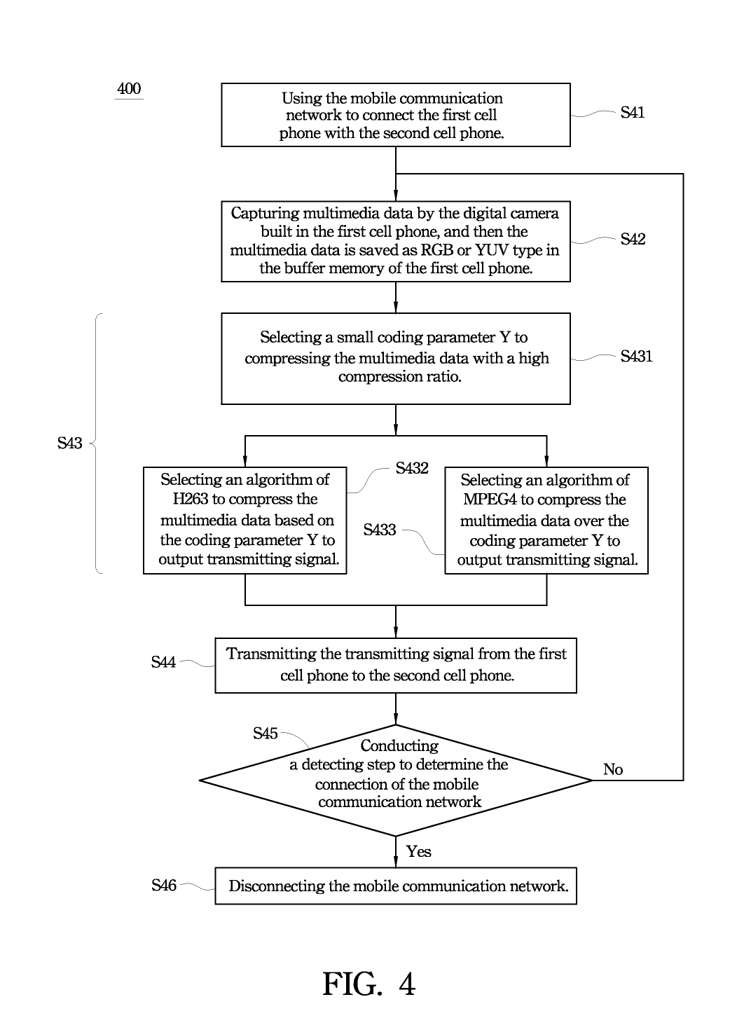

FIG. 4 illustrates a flow chart of a multimedia data dynamic coding method 400 for cell phones in accordance with another preferred embodiment of the present invention. The method 400 is similar to the method 200 shown in FIG. 2 except the way in selecting coding mode.

The method 400 comprises steps as follows: First, the mobile communication network 107 connects the first cell phone 101 to the second cell phone 102 as shown in FIG. 1 (referring to step 41).

In step S42 multimedia data is captured. For example in the present invention, multimedia data captured by the digital camera 103 built in the first cell phone 101,and then the multimedia data is saved as RGB or YUV type in the buffer memory (not shown) of the first cell phone 101.

Subsequently, step S43 is then conducted to select a coding mode so as to determine the coding parameter Y. In the present embodiment, the “network-service-first mode” is manually selected from the “selecting menu” of the “setting” function list under the main menu of the first cell phone 101. Therefore, a small coding parameter Y is obtained and the video data is compressed by a high compression ratio (referring to the step S431) so as to reduce the volume of the transmitting signal (the compressed video data) and save the transmitting capacity of the mobile communication network 107.

In the present embodiment, the coding parameter Y with a predetermined value of 3 is obtained, and then the H263 algorithm (referring to step S432) or MPEG4 algorithm (referring to step S433) is selected. Such that the video data saved in the buffer memory is compressed by a high compression ratio to output transmitting signal.

After the video data is compressed step S44 is then conducted, the transmitting signal is transmitted from the first cell phone 101 to the second cell phone 102. A detecting step S45 is then conducted to determine the connection of the mobile communication network 107 between the two cell phones 101 and 102. If the connection of the mobile communication network 107 is continuous, a loop of steps S41, S42, S43, S44 and S45 are continually conducted until the connection is broken off. When the user wants to cease or terminate the transmission, a step S46 disconnects the mobile communication network 107.

The advantage of applying the “network-service-first mode” is that: the video data can be compressed with a high compression ratio without respect to the flow rate of the mobile network 107, and the other signal can be transmitted prior to the compressed video data, when the flow rate of the mobile network 107 is low. Thus the video data does not occupy the transmitting capacity of the mobile communication network 107 too much to break off the transmission for the other data.

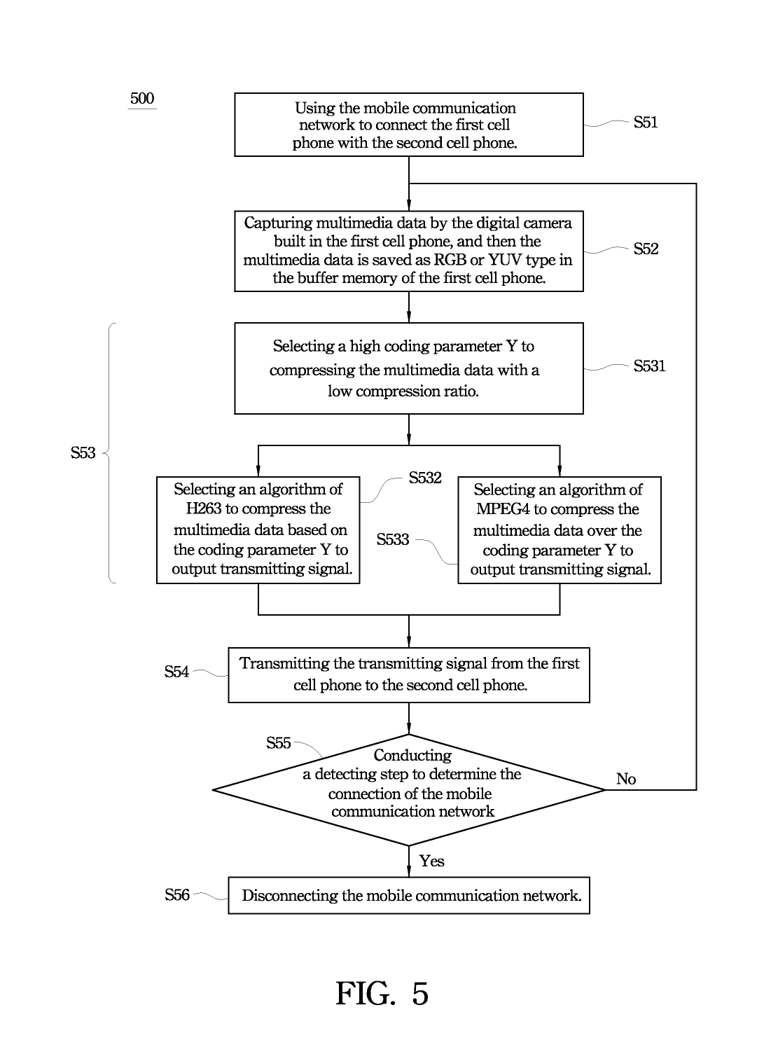

FIG. 5 illustrates a flow chart of a multimedia data dynamic coding method 500 for cell phones in accordance with further another preferred embodiment of the present invention. The method 500 is similar to the method 400 shown in FIG. 4 except the way in selecting coding mode.

The method 500 comprises steps as follows: First, the mobile communication network 107 connects the first cell phone 101 with the second cell phone 102 as shown in FIG. 1 (referring to step 51).

In step S52 multimedia data is captured. For example in the present invention, multimedia data is captured by the digital camera 103 built in the first cell phone 101,and then the multimedia data is saved as RGB or YUV type in the buffer memory of the first cell phone 101.

Subsequently, in step S53 a coding mode is selected so as to determine the coding parameter. In the present embodiment, the “video-data-first mode” is manually selected from the “selecting menu” of the “setting” function list under the main menu of the first cell phone 101. Therefore, a high coding parameter Y is obtained and the video data is compressed with a low compression ratio (referring to the step S531). In the present embodiment, the coding parameter Y with a predetermined value of 63 is obtained, and then as the H263 algorithm (referring to step S533) or MPEG4 algorithm (referring to step S534) is selected. Such that the video data saved in the buffer memory is compressed with a low compression ratio to output transmitting signal.

The advantage of applying the “video-data-first mode” is that the video data can be compressed with a low compression ratio, and the compressed video data can be transmitted prior the other signal without respect to the flow rate of the mobile network 107. Thus the second cell phone 102 that receives the transmitting signal (of the compressed video data) can redisplay the images with better quality.

After the video data is compressed the step S54 is then conducted, the transmitting signal is transmitted from the first cell phone 101 to the second cell phone 102. A detecting step S55 is then conducted to determine the connection situations between the two cell phones 101 and 102. If the connection is continuing, a loop of steps S51, S52, S53, S54 and S55 are continually conducted until the connection is broken off. When the user wants to cease or terminate the transmission, a step S56 of disconnecting the mobile communication network 107 can be conducted.

In accordance with the embodiments of present invention, the characteristics of the present invention are to select a coding mode from a series of coding modes to dynamically code the multimedia data captured by a first cell phone according to the coding mode and a coding parameter, and to transmit the coded multimedia data to a second cell phone through a mobile communication network, wherein the coding mode and the coding parameter can be selected depending upon the performance of the mobile communication network, such as the flow rate, to protect the transmission of the multimedia data from break off. Hence, problems caused by undesired variations of the flow rate of a mobile communication network can be resolved.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A multimedia data dynamic coding method for cell phones, the multimedia data dynamic coding method comprising:
using a first cell phone to capture multimedia data;
selecting a coding mode to determine a coding parameter;
coding the multimedia data according to the coding mode and the coding parameter to output at least one signal; and
transmitting the signal to a second cell phone.

2. The method in accordance with claim 1, wherein the multimedia data includes audio data captured by a microphone built in the first cell phone.

3. The method in accordance with claim 1, wherein the multimedia data includes video data captured by a digital camera built in the first cell phone.

4. The method in accordance with claim 1, further comprising a step of connecting the first cell phone with the second cell phone through a mobile communication network prior to capturing the multimedia data.

5. The method in accordance with claim 4, wherein the coding mode comprises a dynamic adjusting mode.

6. The method in accordance with claim 5, wherein operating the dynamic adjusting mode comprises:
detecting a performance of the mobile communication network to output a mobile function parameter; and
outputting the coding parameter based on the mobile function parameter.

7. The method in accordance with claim 6, wherein the relation between the function parameter X and the coding parameter Y can be represented by the formula Y=log X.

8. The method in accordance with claim 1, wherein the coding mode comprises a video-data-first mode.

9. The method in accordance with claim 8, wherein operating the video-data-first mode comprises predetermining the coding parameter to compress the multimedia data with a low compression ratio to output the signal.

10. The method in accordance with claim 9, wherein the value of the coding parameter is 63.

11. The method in accordance with claim 1, wherein the coding mode comprises a network-service-first mode.

12. The method in accordance with claim 11, wherein operating the network-service-first mode comprises predetermining the coding parameter to compress the multimedia data with a high compression ratio to output the signal.

13. The method in accordance with claim 12, wherein the value of the coding parameter is 3.

14. The method in accordance with claim 1, wherein the coding mode comprises an H263 algorithm or a MPEG4 algorithm used to compress the multimedia data.

15. The method in accordance with claim 1, wherein the coding mode comprises an algorithm of ARM or AAC used to compress the multimedia data.

16. The method in accordance with claim 1, wherein the coding mode can be manually selected from a selecting menu of the setting function list under a main menu of the first cell phone.
